(19) United States
(12) Patent Application Publication
(10) Pub. No.: US 2025/0269506 A1
(43) Pub. Date: Aug. 28, 2025

(54) FASTENER DRIVING DEVICE

(71) Applicant: TOGROUP TECHNOLOGY (SUZHOU) CO., LTD., SUZHOU (CN)

(72) Inventor: YING XU, SUZHOU (CN)

(21) Appl. No.: 18/585,059

(22) Filed: Feb. 23, 2024

(51) Int. Cl. B25C 1/04; B25C 1/00; B25C 1/06

(52) U.S. Cl. CPC B25C 1/047; B25C 1/06; B25C 1/005

(57) ABSTRACT

A fastener driving device includes an energy storage unit, an impact unit, a clutch unit, a power unit and a first buffer. The clutch unit includes a guiding mechanism, a driving mechanism, an engaging mechanism and a resetting mechanism. The engaging mechanism drives the driving mechanism to rotate. The engaging mechanism moves away from the driving mechanism for disengagement under a guidance of the guiding mechanism when the engaging mechanism is cooperated with the guiding mechanism, the engaging mechanism moves close to the driving mechanism for reengagement under an action of the resetting mechanism when the engaging mechanism is out of cooperation with the guiding mechanism. The driving mechanism includes a colliding portion, when the engaging mechanism is disengaged from the driving mechanism, an impactor of the impact unit drives the driving mechanism to rotate, the colliding portion strikes the first buffer.

### FIELD OF THE PRESENT INVENTION

The present invention relates to a field of mechanical tool products, specifically relating to a type of fastener driving device.

### BACKGROUND OF THE PRESENT INVENTION

For rapid fastening devices (also known as nail guns or fastener driving devices), energy is typically stored by compressing an energy storage unit (e.g., gas, compressed springs, rubber, vacuum, etc.). This stored energy is then rapidly released to perform external work.

In existing technology, the rapid fastening devices generally use an incomplete gear-rack structure as a driving mechanism, the driving mechanism drives an impact unit to move, the impact unit compresses the energy storage unit to store energy. When the energy storage unit releases energy to drive the impact unit for driving fasteners into an object, the driving mechanism is separated from the impact unit. This leads to a problem that the driving mechanism cannot be correctly cooperated with the impact unit in a condition that the fastener is stuck. This is not conducive to improving the efficiency of the transmission, greatly increasing the time required for the work cycle, and cannot ensure the stable and smooth operation of the impact unit.

### SUMMARY OF THE PRESENT INVENTION

The present invention provides a fastener driving device that operates stably and smoothly.

Specifically, the present invention provides a fastener driving device including an energy storage unit, an impact unit, a clutch unit and a power unit, the impact unit is connected to the energy storage unit, the impact unit includes an impactor for driving an energy storage unit to store energy and utilizing the energy released by the energy storage unit to drive a fastener into a workpiece; the clutch unit includes a guiding mechanism, a driving mechanism, an engaging mechanism and a resetting mechanism, the driving mechanism is cooperated with the impactor, the engaging mechanism is engaged with the driving mechanism; the power unit includes a rotatable output shaft, the output shaft drives the engaging mechanism to rotate, the engaging mechanism drives the driving mechanism to rotate; the engaging mechanism moves away from the driving mechanism for disengagement under a guidance of the guiding mechanism when the engaging mechanism is cooperated with the guiding mechanism, and the engaging mechanism moves close to the driving mechanism for reengagement under an action of the resetting mechanism when the engaging mechanism is out of cooperation with the guiding mechanism; the fastener driving device further includes a first buffer, the driving mechanism further includes a colliding portion, when the engaging mechanism is disengaged from the driving mechanism, the energy storage unit releases the energy to drive the impactor to move, the impactor drives the driving mechanism to rotate, the colliding portion strikes the first buffer.

The driving mechanism of the present invention can be properly cooperated with the impact unit, the rotational movement of the driving mechanism being converted into the linear movement of the impact unit can be utilized maximally, ensuring stable and smooth operation of the impact unit.

### BRIEF DESCRIPTION OF THE DRAWINGS

FIG. 1 is a schematic diagram of the fastener driving device of the present invention;

FIG. 2 is a cross-sectional view along A-A as shown in FIG. 1;

FIG. 3 is a cross-sectional view along B-B as shown in FIG. 1;

FIG. 4 is a schematic diagram of a partial structure of the fastener driving device as shown in FIG. 1;

FIG. 5 is a schematic diagram from another angle of the partial structure of the fastener driving device as described in FIG. 4;

FIG. 6 is an exploded view of the partial structure as shown in FIG. 4, with the impactor being removed;

FIG. 7 is a schematic diagram showing a plurality of states in the working cycle of the fastener driving device of the present invention;

FIG. 8 is another schematic diagram showing a plurality of states in the working cycle of the fastener driving device of the present invention;

FIG. 9 is a schematic diagram showing a plurality of states of the fastener driving device of the present invention in a condition that the fastener is stuck;

FIG. 10 is another schematic diagram showing a plurality of states of the fastener driving device of the present invention in a condition that the fastener is stuck.

### DETAILED DESCRIPTION OF THE EMBODIMENTS

Here, exemplary embodiments will be explained in detail, which are illustrated in the accompanying drawings. When referring to the drawings in the following description, the same numbers in different drawings represent the same or similar elements, unless otherwise indicated. The embodiments described in the following exemplary embodiments do not represent all embodiments consistent with the present invention.

The terminology used in the present invention is solely for the purpose of describing specific embodiments and is not intended to limit the present invention. Unless otherwise defined, the technical and scientific terms used in this utility model should be understood in their usual sense by those skilled in the art to which this utility model belongs. The words “first,” “second,” etc., used in the present invention do not indicate any order, quantity, or importance but are merely used to distinguish different components. Similarly, the words “a” or “an” do not indicate a quantity limit, but rather that there exists at least one. “Multiple” or “a plurality of” means two or more. Unless otherwise indicated, terms like “front,” “rear,” “bottom,” and/or “top” are used only for convenience and are not limited to a position or spatial orientation.

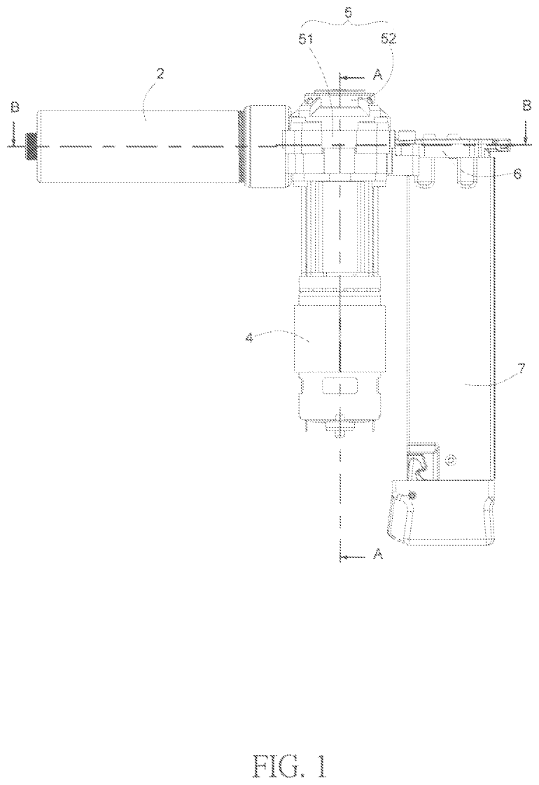

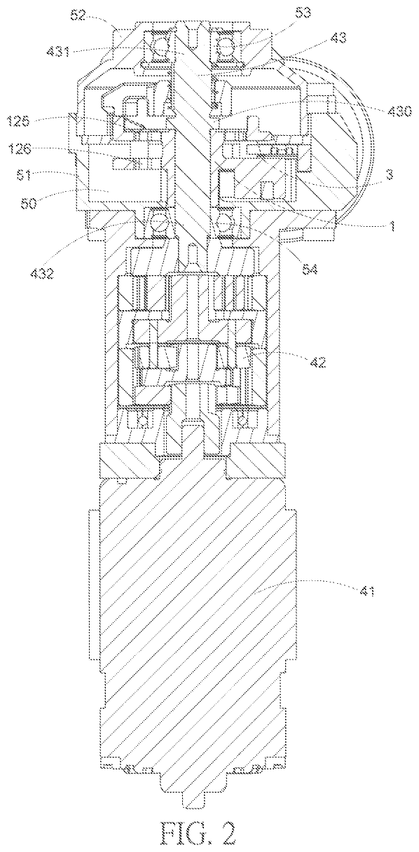

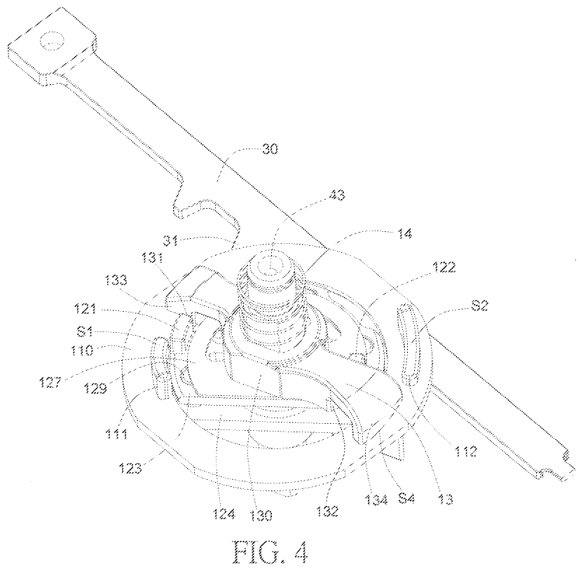

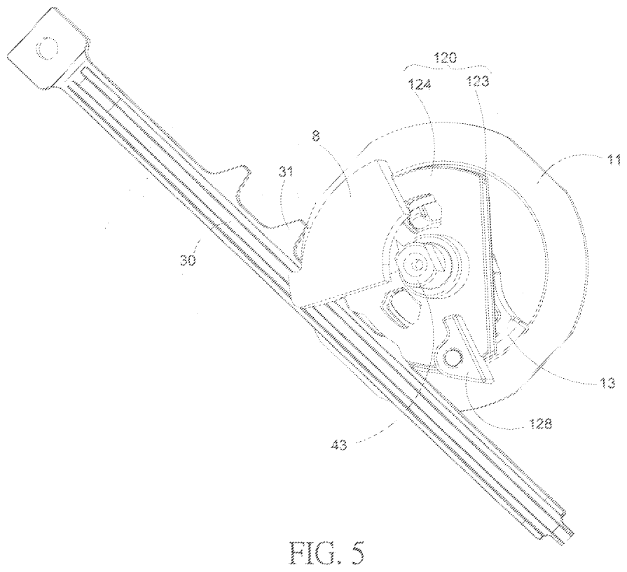

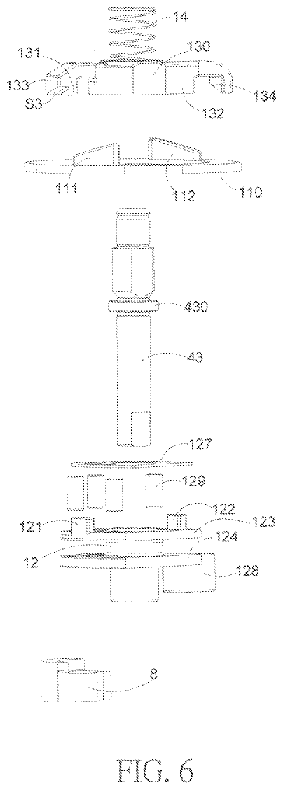

Referencing FIGS. 1 to 10, the fastener driving device of the present invention includes a clutch unit 1, an energy storage unit 2, an impact unit 3, and a power unit 4. The fastener driving device includes a base body 5; the base body 5 includes a mounting space 50, and the clutch unit 1 is mounted in the mounting space 50. Specifically, the base body 5 includes a base 51 and a cover 52 set on the base 51; the base 51 and the cover 52 form the mounting space 50, and the clutch unit 1 is mounted in the mounting space 50.

The fastener driving device also includes a fastener guiding plate 6 and a fastener storage clip 7. The fastener guiding plate 6 is connected to the base 51, and the fastener storage clip 7 is connected to the fastener guiding plate 6. The fastener storage clip 7 contains a plurality of fasteners (not shown in the FIGS), which are used to be driven into the workpiece by the impact unit 3. The fastener storage clip 7 can feed the plurality of fasteners to the fastener guiding plate 6, and the fastener guiding plate 6 receives the plurality of fasteners from the fastener storage clip 7, the fastener guiding plate 6 performs a guiding function for the fasteners. In this embodiment, the fasteners are nails, the fastener guiding plate 6 is a nail guiding plate, and the fastener storage clip 7 is a nail storage clip.

The impact unit 3 includes an impactor 30 for driving the energy storage unit 2 to store energy and utilizing the energy released by the energy storage unit 2 to drive the fastener into the workpiece. The impactor 30 is shaped as a long strip, the impactor 30 passes through the mounting space 50 to connect to the energy storage unit 2.

The clutch unit 1 includes a guiding mechanism 11, a driving mechanism 12, an engaging mechanism 13 and a resetting mechanism 14. The driving mechanism 12 is cooperated with the impactor 30. The engaging mechanism 13 is engaged with the driving mechanism 12. The engaging mechanism 13 moves away from the driving mechanism 12 for disengagement under a guidance of the guiding mechanism 11.

The power unit 4 includes an electric motor 41, a gear transmitting mechanism 42, and a rotatable output shaft 43. The rotational speed and the torque outputted by the electric motor 41 are transmitted to the output shaft 43 via the gear transmitting mechanism 42. The output shaft 43 is connected to the engaging mechanism 13, the output shaft 43 drives the engaging mechanism 13 to move. During the rotation of the engaging mechanism 13, the engaging mechanism 13 moves away from the driving mechanism 12 for disengagement under a guidance of the guiding mechanism 11 when the engaging mechanism 13 is cooperated with the guiding mechanism 11, and the engaging mechanism 13 moves close to the driving mechanism 12 for reengagement under an action of the resetting mechanism 14 when the engaging mechanism 13 is out of cooperation with the guiding mechanism 11.

The gear transmitting mechanism 42 is connected to the base 51 and is used for reducing the rotational speed while increasing the torque. The gear transmitting mechanism 42 includes one stage of planetary gear or a plurality of stages of planetary gear; in this embodiment, the gear transmitting mechanism 42 includes three stages of planetary gear. The output shaft 43 is located between the cover 52 and the base 51. The base body 5 also includes a first bearing 53 and a second bearing 54, both ends of the output shaft 43 is respectively supported by the first bearing 53 and the second bearing 54, specifically, the first end 431 of the output shaft 43 is supported by the first bearing 53, the first bearing 53 is located between the cover 52 and the first end 431 of the output shaft 43; the second end 432 of the output shaft 43 is supported by the second bearing 54, the second bearing 54 is located between the base 51 and the second end 432 of the output shaft 43. It should be noted that the gear transmitting mechanism 42 is not essential; when the torque outputted by the electric motor 41 is sufficiently large, the shaft of the motor can be directly served as the output shaft 43.

The energy storage unit 2 is connected to the base 51 and serves as a medium that can store energy through displacement, such as air springs, mechanical springs, rubber components and vacuum, etc. In this embodiment, the energy storage unit 2 is an air spring, the energy storage unit 2 includes a cylinder 21, a piston 22 and a sealing ring 23. The cylinder 21 and the piston 22 form an enclosed space 20 containing gas, a gap between the cylinder 21 and the piston 22 are sealed by the sealing ring 23. One end of the impactor 30 is connected to the piston 22 through the mounting space 50, and the other end of the impactor 30 is used to drive the fastener into the workpiece. The impactor 30 can move along with the piston 22.

The clutch unit 1 is located between the first bearing 53 and the second bearing 54. Both the driving mechanism 12 and the engaging mechanism 13 are sleeved on the output shaft 43 and are adjacent to each other, that is, the driving mechanism 12 is adjacent to the engaging mechanism 13 in an axial direction of the output shaft 43. The engaging mechanism 13 is located between the driving mechanism 12 and the first bearing 53. The guiding mechanism 11 is fixed in the mounting space 50. The guiding mechanism 11 is an annular structure, the guiding mechanism 11 is sleeved on the driving mechanism 12. In this embodiment, the driving mechanism 12 can rotate around the output shaft 43; the engaging mechanism 13 is sleeved on the output shaft 43 and is movable along an axial direction of the output shaft, the engaging mechanism 13 can move relative to the driving mechanism 12 along the axial direction of the output shaft 43. The output shaft 43 drives the engaging mechanism 13 to rotate, that is to say, the engaging mechanism 13 rotates with the output shaft 43.

The resetting mechanism 14 is located on a side, away from the driving mechanism 12, of the engaging mechanism 13; the resetting mechanism 14 presses against the engaging mechanism 13. Specifically, the resetting mechanism 14 is mounted between the first bearing 53 and the engaging mechanism 13. One end of the resetting mechanism 14 presses against the engaging mechanism 13, and the other end of the resetting mechanism 14 presses against the first bearing 53. In this embodiment, the resetting mechanism 14 is an elastic resetting member, specifically, the elastic resetting member is a spring, the spring is sleeved on the output shaft 43. One end of the spring presses against the engaging mechanism 13, and the other end of the spring presses against the first bearing 53.

The guiding mechanism 11 includes at least one guiding portion, the driving mechanism 12 includes at least one engaging tooth, and the engaging mechanism 13 includes at least one engaging portion and at least one cooperating portion. The output shaft 43 drives the engaging mechanism 13 to rotate. During the rotation of the engaging mechanism 13, the at least one engaging portion is engaged with the at least one engaging tooth, so that the engaging mechanism 13 drives the driving mechanism 12 to rotate; the at least one cooperating portion is cooperated with the at least one guiding portion, so that the at least one engaging portion moves away from the at least one engaging tooth for disengagement under a guidance of the at least one guiding portion.

Specifically, the guiding mechanism 11 includes a main body 110, a first guiding portion 111 and a second guiding portion 112; the first guiding portion 111 and the second guiding portion 112 are arranged on the main body 110. Both the first guiding portion 111 and the second guiding portion 112 are located on a side, close to the engaging mechanism 13, of the main body 110. The first guiding portion 111 has a first mating surface S1, and the second guiding portion 112 has a second mating surface S2. Both the first mating surface S1 and the second mating face S2 face towards the engaging mechanism 13.

The engaging mechanism 13 includes a base portion 130, a first engaging portion 131 extending from one side of the base portion 130, a first cooperating portion 133 extending from the first engaging portion 131, a second engaging portion 132 extending from the other side of the base portion 130, and a second cooperating portion 134 extending from the second engaging portion 132. The first cooperating portion 133 and the second cooperating portion 134 extend in a direction that is perpendicular or nearly perpendicular to the axial direction of the output shaft 43, the first engaging portion 131 and the second engaging portion 132 extend in a direction that is perpendicular or nearly perpendicular to the axial direction of the output shaft 43.

In the radial direction of the output shaft 43, the first engaging portion 131 is closer to the base portion 130 than the first cooperating portion 133, and the second engaging portion 132 is closer to the base portion 130 than the second cooperating portion 134. The base portion 130 is sleeved on the output shaft 43. The radial direction of the output shaft 43 is perpendicular to the axial direction of the output shaft 43. The first cooperating portion 133 has a third mating surface S3, and the second cooperating portion 134 has a fourth mating surface S4. Both the third mating surface S3 and the fourth mating surface S4 face towards the guiding mechanism 11. The third mating surface S3 of the first cooperating portion 133 is cooperated with the first mating surface S1 of the first guiding portion 111, and the fourth mating surface S4 of the second cooperating portion 134 is cooperated with the second mating surface S2 of the second guiding portion 112.

In this embodiment, the first guiding portion 111 and the second guiding portion 112 are arranged on different circumferences centered on a point on the central axis of the output shaft 43; the first cooperating portion 133 and the second cooperating portion 134 are also arranged on different circumferences centered on a point on the central axis of the output shaft 43. In the radial direction of the output shaft 43, the first guiding portion 111 and the second guiding portion 112 are corresponding to each other, the first cooperating portion 133 and the second cooperating portion 134 are corresponding to each other.

During the rotation of the engaging mechanism 13 with the output shaft 43, the relationship between the mating surface of the cooperating portion and the mating surface of the guiding portion is changed from “begin to cooperate” to “out of cooperation”. The detailed process is as follows: The mating surface of the cooperating portion and the mating surface of the guiding portion begin to cooperate, and under the guidance of the mating surface of the guiding portion, the engaging mechanism 13 moves away from the driving mechanism 12 in the axial direction of the output shaft 43. The engaging mechanism 13 is disengaged from the driving mechanism 12, and the engaging mechanism 13 continues to rotate with the output shaft 43, the mating surface of the cooperating portion is out of cooperation with the mating surface of the guiding portion. In this embodiment, the mating surfaces are spiral surfaces, and the helix angle of the spiral surface of the guiding portion is not greater than 60°.

Preferably, each of the first mating surface S1 and the second mating surface S2 has a first edge close to the output shaft 43 and a second edge far away from the output shaft 43. The distance D1 between the second edge of the first mating surface S1 and the output shaft 43 is less than the distance D2 between the first edge of the second mating surface S2 and the output shaft 43. When the first cooperating portion 133 is rotated to a position which is corresponding to the position of the second guiding portion 112 along the radial direction of the output shaft 43, the third mating surface S3 of the first cooperating portion 133 is not cooperated with the second mating surface S2 of the second guiding portion 112, and the fourth mating surface S4 of the second cooperating portion 134 is not cooperated with the first mating surface

S1 of the first guiding portion 111. Thus, as the engaging mechanism 13 rotates one full circle with the output shaft 43, the impact unit 3 only achieves a complete reciprocating movement, i.e., the impact unit 3 achieves one driving action, avoiding too frequent driving actions from affecting stability of the fastener driving device.

The driving mechanism 12 includes a bracket 120 and a plurality of pins 129 mounted on the bracket 120, the bracket 120 is rotatably sleeved on the output shaft 43. The bracket 120 is generally shaped as a disk. The plurality of pins 129 are arranged in a circumferential direction. The bracket 120 includes a first sub-bracket 123 and a second sub-bracket 124 which are corresponding to each other along the axial direction of the output shaft 43. The first sub-bracket 123 is closer to the engaging mechanism 13 than the second sub-bracket 124. The first sub-bracket 123 includes a plurality of first pin holes 125. The second sub-bracket 124 includes a plurality of second pin holes 126. Both ends of the pin 129 are respectively inserted into the first pin hole 125 and the second pin hole 126 which are corresponding to each other along the axial direction of the output shaft 43. The impactor 30 includes a plurality of driving teeth 31, the plurality of driving teeth 31 are engaged with the plurality of pins 129. The driving mechanism 12 further includes a pad 127, the pad 127 is located on a side, close to the engaging mechanism 13, of the bracket 120. The pad 127 presses against the bracket 120 and covers at least a part of an area of the first pin hole 125, to prevent the pin 129 from falling out of the first pin hole 125. In this embodiment, the pin and the pin hole are designed for clearance fit, so a pad 127 is needed to prevent the pin 129 from falling out of the first pin hole 125. It should be noted that the pad 127 is not mandatory; the pad 127 can be omitted if the pin and the pin hole are designed for interference fit. In this embodiment, the pin and the pin hole are designed for clearance fit, to reduce the friction between the pins 129 and the driving teeth 31.

The driving mechanism 12 also includes a first engaging tooth 121 and a second engaging tooth 122 located on the bracket 120. The first engaging tooth 121 and the second engaging tooth 122 face towards the engaging mechanism 13. Specifically, the first engaging tooth 121 is engaged with the first engaging portion 131 of the engaging mechanism 13, and the second engaging tooth 122 is engaged with the second engaging portion 132 of the engaging mechanism 13. In detail, “engagement between the engaging portion and the engaging tooth” means “the side face of the engaging portion presses against the side face of the engaging tooth”. Specifically, the engaging tooth includes a first engaging surface, and the engaging portion includes a second engaging surface, the first engaging surface is cooperated with the second engaging surface. Both the first engaging surface and the second engaging surface are perpendicular to a plane of rotation of the bracket 120, the plane of rotation of the bracket 120 is perpendicular to a plane where the center axis of the output shaft 43 is located. The output shaft 43 drives the engaging mechanism 13 to rotate. When the engaging portions are engaged with the engaging teeth, the engaging mechanism 13 drives the driving mechanism 12 to rotate, when the pins 129 are engaged with the driving teeth 31, the driving mechanism 12 drives the impactor 30 to move along a first direction, the first direction is a direction which is towards the energy storage unit 2, the impactor compresses the piston 22, then energy can be stored by the energy storage unit 2. In this embodiment, via the engagement between the pins 129 of the driving mechanism 12 and the driving teeth 31 of the impactor 30, a rotational movement of the driving mechanism 12 is transformed into a linear movement of the impactor 30.

In the present invention, the output shaft 43 rotates counterclockwise to drive the engaging mechanism 13 to rotate counterclockwise. The relationship between the mating surfaces (i.e., the third mating surface S3 and the fourth mating surface S4) of the cooperating portions (i.e., the first cooperating portion 133 and the second cooperating portion 134) of the engaging mechanism 13 and the mating surfaces (i.e., the first mating surface S1 and the second mating surface S2) of the guiding portions (i.e., the first guiding portion 111 and the second guiding portion 112) of the guiding mechanism 11 is changed from “begin to cooperate” to “out of cooperation”, during a process of “begin to cooperate” to “out of cooperation”, the engaging mechanism 13 moves away from the driving mechanism 12 along the axial direction of the output shaft 43 until the engaging portions of the engaging mechanism 13 are about to be disengaged from the engaging teeth of the driving mechanism 12, the output shaft 43 continues to rotate counterclockwise, the engaging portions of the engaging mechanism 13 are disengaged from the engaging teeth of the driving mechanism 12.

When the engaging portions of the engaging mechanism 13 are disengaged from the engaging teeth of the driving mechanism 12, under an action of the energy storage unit 2 (i.e., the pressure from the energy storage unit 2 acts on the impactor 30), the impactor 30 drives the driving mechanism 12 to move rapidly (i.e., the impactor 30 moves away from the energy storage unit 2, while the driving mechanism 12 rotates clockwise). The impactor 30 drives the fasteners received in the fastener guiding plate 6 into the workpiece (i.e., typically wood, metal plates or concrete). The driving mechanism 12 returns to its initial position. The output shaft 43 continues to rotate an angle in a counterclockwise direction, the cooperating portions (i.e., the first cooperating portion 133 and the second cooperating portion 134) of the engaging mechanism 13 are disengaged from the guiding portions (i.e., the first guiding portion 111 and the second guiding portion 112) of the guiding mechanism 11, under an action of the resetting mechanism, the engaging mechanism 13 moves close to the driving mechanism 12 along the axial direction of the output shaft 43 to return to its initial position. In this embodiment, the output shaft 43 includes a shoulder 430 as a stopping portion, under the action of the resetting mechanism, the engaging mechanism 13 moves close to the driving mechanism 12 until the engaging mechanism 13 presses against the shoulder 430 of the output shaft 43.

The fastener driving device also includes a first buffer 8 mounted between the base 51 and the driving mechanism 12. This first buffer 8 is located on a side, away from the engaging mechanism 13, of the bracket 120. The driving mechanism 12 further includes a colliding portion 128; the colliding portion 128 is located on a side, away from the engaging mechanism 13, of the bracket 120. During the rotation of the driving mechanism 12 (i.e., the driving mechanism 12 is driven by the impactor 30), the colliding portion 128 will strikes the first buffer 8.

Specifically, when the impactor 30 moves away from the energy storage unit 2 along a second direction and drives the driving mechanism 12 to rotate in a clockwise direction, the driving mechanism 12 carries a certain amount of rotational energy. When the impactor 30 completes a driving action for the fasteners, the residual rotational energy of the driving mechanism 12 will be absorbed or dissipated by the first buffer 8, in this design, the driving mechanism 12 and/or the impactor 30 can be prevented from being damaged. The first buffer 8 is located on a side, away from the engaging mechanism 13, of the bracket 120; at least part of the first buffer 8 is distributed along a circumference of the bracket 120. In this design, it is convenient for the first buffer 8 to absorb or dissipate the residual rotational energy of the driving mechanism 12.

The first buffer 8 is generally made of rubber or other elastic material such as thermoplastic elastomer, and the first buffer 8 can also be a spring.

The fastener driving device also includes a second buffer 9 mounted between the base 51 and the piston 22. During a process of the impactor 30 driving the energy storage unit 2 to store energy, the impactor 30 pushes the piston 22 to move away from the second buffer 9. During a process of the impactor 30 being subjected to the energy released by the energy storage unit 2 to drive the fasteners into the workpiece, the piston 22 pushes the impactor 30 to move in a direction which is towards the second buffer 9 until the piston 22 strikes the second buffer 9. When the impactor 30 completes the driving action for the fastener, the residual energy of the piston 22 is absorbed or dissipated by the second buffer 9. In this design, the driving mechanism 12 and/or the impactor 30 can be prevented from being damaged.

When the impactor 30 completes the driving action for the fastener, the output shaft 43 continues to rotate an angle in a counterclockwise direction, the cooperating portions (i.e., the first cooperating portion 133 and the second cooperating portion 134) of the engaging mechanism 13 are disengaged from the guiding portions (i.e., the first guiding portion 111 and the second guiding portion 112) of the guiding mechanism 11, under the action of the resetting mechanism 14, the engaging mechanism 13 moves close to the driving mechanism 12 along the axial direction of the output shaft 43, to return to its initial position. At this time, because the engaging portions of the engaging mechanism 13 are not engaged with the engaging teeth of the driving mechanism 12, the colliding portion 128 of the driving mechanism 12 and the piston 22 of the energy storage unit 2 are respectively parked at the first buffer 8 and the second buffer 9.

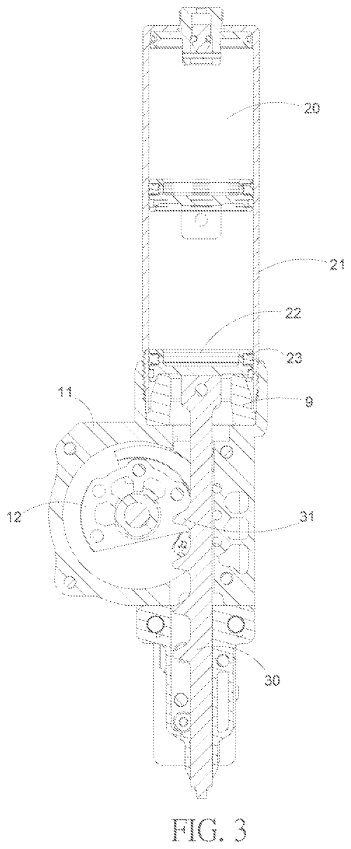

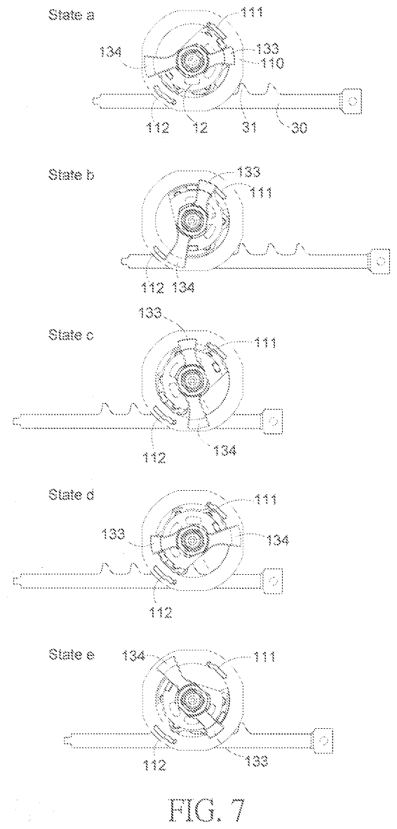

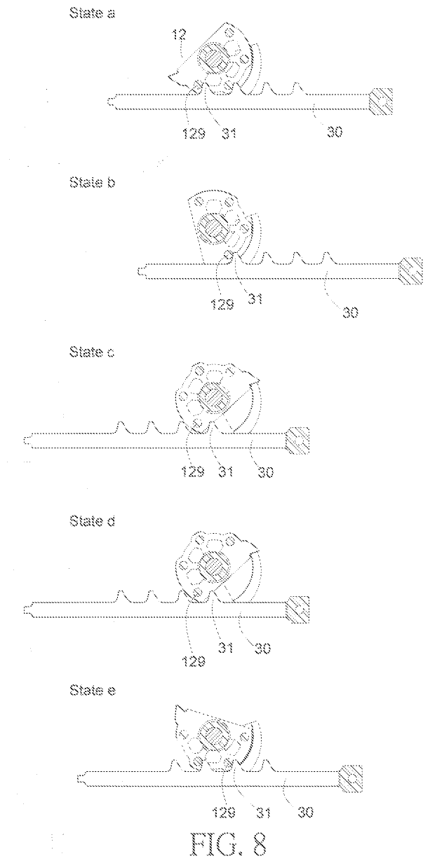

As shown in FIGS. 7 and 8, states a, b, c, d, e are corresponding to a working cycle. The output shaft 43 rotates counterclockwise, the output shaft 43 drives the engaging mechanism 13 to rotate, the engaging mechanism 13 drives the driving mechanism 12 to rotate counterclockwise to the position shown in state a. At this time, the third pin of the driving mechanism 12 is about to be disengaged from the third driving tooth of the impactor 30, and the fourth pin is about to be engaged with the fourth driving tooth. As the output shaft 43 continues to rotate counterclockwise, the fourth pin is engaged with the fourth driving tooth. At this time, the end, close to the piston 22, of the impactor 30 is located at the position shown by the dotted line in FIG. 3. Meanwhile, the mating surfaces (i.e., the third mating surface S3 and the fourth mating surface S4) of the cooperating portions (i.e., the first cooperating portion 133 and the second cooperating portions 134) of the engaging mechanism 13 begin to cooperate with the mating surfaces (i.e., the first mating surface S1 and second mating surface S2) of the guiding portions (i.e., the first guiding portion 111 and the second guiding portion 112) of the guiding mechanism 11. The engaging mechanism 13 moves away from the driving mechanism 12 along the axial direction of the output shaft 43 until the engaging portions of the engaging mechanism 13 are about to be disengaged from the engaging teeth of the driving mechanism 12, as shown in state b. The output shaft 43 continues to rotate counterclockwise, the engaging portions of the engaging mechanism 13 are disengaged from the engaging teeth of the driving mechanism 12. The impactor 30 moves away from the energy storage unit 2 in a second direction under the action of the piston 22, the impactor 30 drives the driving mechanism 12 to rotate, the impactor 30 and the driving mechanism 12 move together at a high speed. Specifically, the driving mechanism 12 rotates in a clockwise direction driven by the impactor 30, and the impactor 30 drives the fasteners received in the fastener guiding plate 6 into the workpiece. The piston 22 strikes the second buffer 9, while the colliding portion 128 of the driving mechanism 12 strikes the first buffer 8. The output shaft 43 continues to rotate an angle in a counterclockwise direction, and the first cooperating portion 133 and the second cooperating portion 134 of the engaging mechanism 13 are disengaged from the first guiding portion 111 and second guiding portion 112 of the guiding mechanism 11. Under the action of the resetting mechanism 14, the engaging mechanism 13 moves close to the driving mechanism 12 along the axial direction of the output shaft 43 to return to its initial position, as shown in state c. At this time, because the engaging portions of the engaging mechanism 13 are not engaged with the engaging teeth of the driving mechanism 12, the colliding portion 128 of the driving mechanism 12 and the piston 22 of the energy storage unit 2 are respectively parked at the first buffer 8 and the second buffer 9.

The output shaft 43 continues to rotate counterclockwise, as shown in state d, the engaging portions of the engaging mechanism 13 are re-engaged with the engaging teeth of the driving mechanism 12, so that the engaging mechanism 13 drives the driving mechanism 12 to rotate, the engaging mechanism 13 and the driving mechanism 12 rotate together. The output shaft 43 continues to rotate counterclockwise, as shown in state e, the engaging mechanism 13 drives the driving mechanism 12 to rotate, and the pins 129 of the driving mechanism 12 are engaged with the driving teeth 31 of the impactor 30 in turn, so that the driving mechanism 12 drives the impactor 30 to move close to the energy storage unit 2, thereby compressing the piston 22 to store energy. In this process, the rotational movement of the driving mechanism 12 is converted into the linear movement of the impactor 30. The output shaft 43 continues to rotate counterclockwise until the engaging mechanism 13 drives the driving mechanism 12 rotate counterclockwise to the position shown in state a.

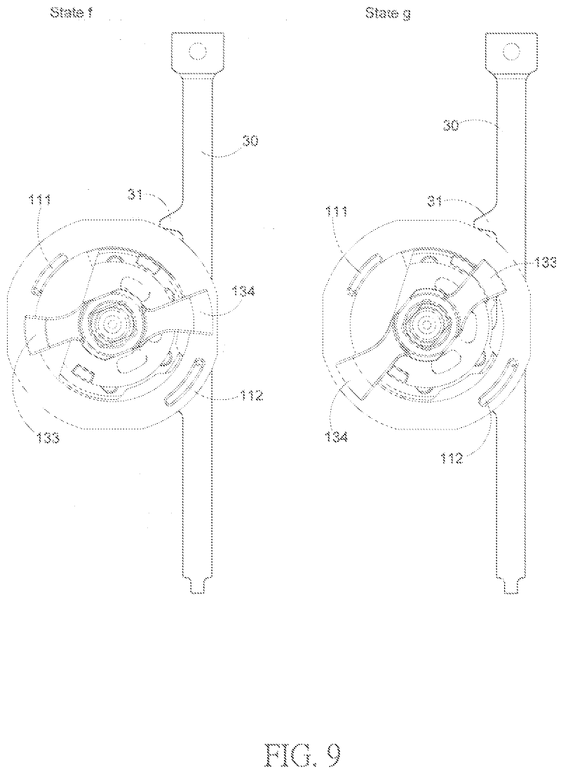

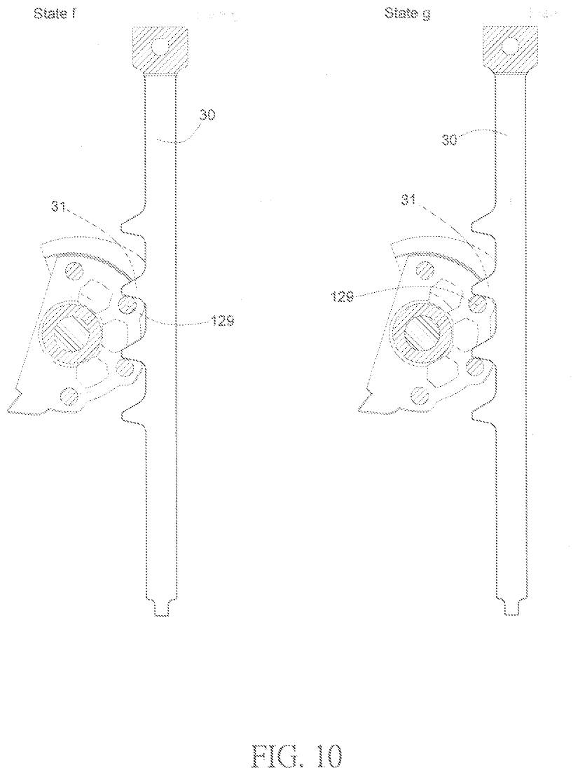

As shown in FIGS. 9 and 10, for some reason, the fastener is stuck in the fastener guiding plate 6, the impactor 30 may stop anywhere along the second direction, as shown in state f. In the process of the driving mechanism 12 driving the impactor 30 to move, it is necessary that at least two pins 129 of the driving mechanism 12 are engaged with at least two driving teeth 31 of the impactor 30, if the pins 129 of the driving mechanism 12 are disengaged from the driving teeth 31 of the impactor 30 when the impactor 30 is moving along the second direction, in a situation that the fastener is stuck, the pins 129 of the driving mechanism 12 may not be correctly re-engaged with the driving teeth 31 of the impactor 30 due to the randomness of the stopping position of the impactor 30. In the present invention, the engagement between the driving teeth 31 of the impactor 30 and the pins 129 of the driving mechanism 12 is always maintained, therefor, even if the fastener is stuck, it is ensured that the pins 129 of the driving mechanism 12 and the driving teeth 31 of the impactor 30 will be correctly engaged.

When the fastener is stuck, the output shaft 43 continues to rotate counterclockwise, the cooperating portions (i.e., the first cooperating portion 133 and the second cooperating portions 134) of the engaging mechanism 13 are disengaged from the guiding portions (i.e., the first guiding portion 111 and the second guiding portion 112) of the guiding mechanism 11. Under the action of the resetting mechanism 14, the engaging mechanism 13 moves close to the driving mechanism 12 along the axial direction of the output shaft 43 to return to its initial position. The engaging mechanism 13 continues to rotate with the output shaft 43, and the engaging portions of the engaging mechanism 13 are engaged with the engaging teeth of the driving mechanism 12, as shown in state g. The output shaft 43 continues to rotate counterclockwise, the output shaft 43 drives the engaging mechanism 13 to rotate, the engaging mechanism 13 drives the driving mechanism 12 to rotate. The driving mechanism 12 can drive the impactor 30 to compress the piston 22, the impactor 30 and the driving mechanism 12 can return to the initial state of the working cycle, as shown in state a.

In the present invention, when the impactor 30 moves along the second direction, the driving teeth 31 of the impactor 30 will not be disengaged from the pins 129 of the driving mechanism 12, even if the fastener is stuck, it is ensured that the driving teeth 31 of the impactor 30 are correctly engaged with the pins 129 of the driving mechanism 12. Moreover, during the energy storage process of the energy storage unit 2, the utilization of the rotational movement of the driving mechanism 12 is maximized, that is, the rotational movement of the driving mechanism 12 is maximally converted into the linear movement of the impactor 30. In addition, a quick release of the energy stored in the energy storage unit 2 can be achieved, the stability and smoothness of the operation of the impactor 30 can be ensured, the quality of the work can be improved, and the time required for the working cycle can be reduced. Even if the fastener is stuck, it can be quickly return to the initial state of the working cycle, it is more convenient to use the fastener driving device.

The above description is only the preferred embodiment of the present invention and is not intended to limit the present invention in any form. Although the present invention has been disclosed as above in the preferred embodiment, it is not intended to limit the application. Any simple modifications, equivalent changes, and modifications made to the above embodiments by anyone skilled in the art, without departing from the technical scope of the present invention, still fall within the scope of the present invention.

I claim:

1. A fastener driving device, comprising:
an energy storage unit;
an impact unit, connected to the energy storage unit, the impact unit comprising an impactor for driving an energy storage unit to store energy and utilizing the energy released by the energy storage unit to drive a fastener into a workpiece;
a clutch unit, comprising a guiding mechanism, a driving mechanism, an engaging mechanism and a resetting mechanism, the driving mechanism being cooperated with the impactor, the engaging mechanism being cooperated with the driving mechanism;
a power unit, comprising a rotatable output shaft, the output shaft driving the engaging mechanism to rotate, the engaging mechanism driving the driving mechanism to rotate; wherein
the engaging mechanism moves away from the driving mechanism for disengagement under a guidance of the guiding mechanism when the engaging mechanism is cooperated with the guiding mechanism, and the engaging mechanism moves close to the driving mechanism for reengagement under an action of the resetting mechanism when the engaging mechanism is out of cooperation with the guiding mechanism; the fastener driving device further comprises a first buffer, the driving mechanism further comprises a colliding portion, when the engaging mechanism is disengaged from the driving mechanism, the energy storage unit releases the energy to drive the impactor to move, the impactor drives the driving mechanism to rotate, the colliding portion strikes the first buffer.

2. The fastener driving device according to claim 1, wherein the fastener driving device comprises a base body, the base body comprises a mounting space, the clutch unit is mounted in the mounting space, the impactor passes through the mounting space to connect to the energy storage unit.

3. The fastener driving device according to claim 2, wherein the driving mechanism is sleeved on the output shaft, the guiding mechanism is fixedly mounted in the mounting space and is sleeved on the driving mechanism, the engaging mechanism is sleeved on the output shaft and is movable along an axial direction of the output shaft, the driving mechanism is adjacent to the engaging mechanism in the axial direction of the output shaft.

4. The fastener driving device according to claim 3, wherein the driving mechanism comprises a bracket and a plurality of pins mounted on the bracket, the bracket is rotatably sleeved on the output shaft, the bracket comprises a first sub-bracket and a second sub-bracket corresponding to each other, the first sub-bracket comprises a first pin hole, the second sub-bracket comprises a second pin hole, both ends of the pin are mounted in the first pin hole and the second pin hole respectively, the impactor comprises a plurality of driving teeth, the driving teeth are used for being engaged with the pins.

5. The fastener driving device according to claim 4, wherein the driving mechanism further comprises a pad, the pad presses against the bracket and covers at least a part of an area of the first pin hole, to prevent the pin from being separated from the first pin hole.

6. The fastener driving device according to claim 4, wherein the plurality of pins are distributed in a circumferential direction.

7. The fastener driving device according to claim 5, wherein the first sub-bracket and the second sub-bracket are corresponding to each other along the axial direction of the output shaft, the first sub-bracket is closer to the engaging mechanism relative to the second sub-bracket, the pad is located on a side, close to the engaging mechanism, of the bracket.

8. The fastener driving device according to claim 4, wherein the driving mechanism comprises at least one engaging tooth disposed on the bracket, the at least one engaging tooth faces the engaging mechanism;
the engaging mechanism comprises at least one engaging portion and at least one cooperating portion,
the guiding mechanism comprises at least one guiding portion,
the output shaft drives the engaging mechanism to rotate, during a rotation of the engaging mechanism, the at least one engaging portion is engaged with the at least one engaging tooth, so that the engaging mechanism drives the driving mechanism to rotate; the at least one cooperating portion is cooperated with the at least one guiding portion, so that the at least one engaging portion moves away from the at least one engaging tooth for disengagement under a guidance of the at least one guiding portion.

9. The fastener driving device according to claim 8, wherein each of the guiding portion and the cooperating portion comprises a mating surface, during the rotation of the engaging mechanism, the mating surface of the guiding portion is cooperated with the mating surface of the cooperating portion, so that the engaging portion moves away from the engaging tooth for disengagement under a guidance of the guiding portion.

10. The fastener driving device according to claim 9, wherein the mating surface is a spiral surface.

11. The fastener driving device according to claim 8, wherein the at least one guiding portion comprises at least two guiding portions, the at least two guiding portions are arranged on different circumferences centered on a point on a center axis of the output shaft; the at least one cooperating portion comprises at least two cooperating portions, the at least two cooperating portions are arranged on different circumferences centered on a point on the center axis of the output shaft.

12. The fastener driving device according to claim 11, wherein the at least two guiding portions comprise a first guiding portion and a second guiding portion, the first guiding portion and the second guiding portion are corresponding to each other along a radial direction of the output shaft; the at least two cooperating portions comprise a first cooperating portion and a second cooperating portion, the first cooperating portion and the second cooperating portion are corresponding to each other along the radial direction of the output shaft.

13. The fastener driving device according to claim 2, wherein the resetting mechanism is located on a side, away from the driving mechanism, of the engaging mechanism; and the resetting mechanism presses against the engaging mechanism, one end of the resetting mechanism presses against the engaging mechanism, and the other end of the resetting mechanism presses against the base body; the resetting mechanism is an elastic resetting member.

14. The fastener driving device according to claim 3, wherein the resetting mechanism is a spring, the spring is sleeved on the output shaft, the spring is located on a side, away from the driving mechanism, of the engaging mechanism; one end of the spring presses against the engaging mechanism, and the other end of the spring presses against the base body.

15. The fastener driving device according to claim 4, wherein the first buffer is mounted in the mounting space, the first buffer and the colliding portion are located on a side, away from the engaging mechanism, of the bracket.

16. The fastener driving device according to claim 15, wherein at least a part of the first buffer is distributed along a circumference of the bracket.

17. The fastener driving device according to claim 2, wherein the energy storage unit comprises a cylinder, a piston and a sealing ring; the cylinder and the piston form an enclosed space containing gas, and a gap between the cylinder and the piston are sealed by the sealing ring; when the engaging mechanism is disengaged from the driving mechanism, the piston pushes the impactor to move.

18. The fastener driving device according to claim 17, wherein the fastener driving device further comprises a second buffer mounted in the base body, the piston pushes the impactor to move and strikes the second buffer.

19. The fastener driving device according to claim 8, wherein the engaging tooth comprises a first engaging surface, and the engaging portion comprises a second engaging surface, the first engaging surface is engaged with the second engaging surface, the first engaging surface and the second engaging surface are perpendicular to a plane of rotation of the bracket, the plane of rotation of the bracket is perpendicular to a plane where a center axis of the output shaft is located.

20. The fastener driving device according to claim 10, wherein a helix angle of the spiral surface of the guiding portion is not greater than 60°.
